(19) United States
(12) Patent Application Publication
(10) Pub. No.: US 2026/0111447 A1
(43) Pub. Date: Apr. 23, 2026

(54) DISTRIBUTED OBJECT STORAGE METHOD, DEVICE AND STORAGE MEDIUM

(71) Applicant: Beijing Volcano Engine Technology Co., Ltd., Beijing (CN)

(72) Inventors: Qinshui CHEN, Beijing (CN); Feng LIN, Beijing (CN); Weixing CHEN, Beijing (CN)

(21) Appl. No.: 19/229,637

(22) Filed: Jun. 5, 2025

(30) Foreign Application Priority Data
Oct. 21, 2024 (CN) 202411472759.X

(51) Int. Cl. G06F 16/27; G06F 16/22

(52) U.S. Cl. CPC G06F 16/278; G06F 16/2282

(57) ABSTRACT

A distributed object storage method, a device and a medium are provided, and the method includes: splitting a target object to be stored into a quantity of key-value pair data; determining target partitions corresponding respectively to the quantity of key-value pair data from a plurality of partitions of a preset distributed object storage system; determining, based on a preset partition view, data storage nodes that currently hold the target partitions, to obtain data storage nodes corresponding respectively to the quantity of key-value pair data; and caching the quantity of key-value pair data into the data storage nodes corresponding respectively to the quantity of key-value pair data.

### CROSS-REFERENCE TO RELATED APPLICATION

The present application claims priority of the Chinese Patent Application No. 202411472759.X, filed on Oct. 21, 2024, the disclosure of which is incorporated herein by reference in its entirety as part of the present application.

### TECHNICAL FIELD

The present disclosure relates to the field of computer technologies, and in particular, to a distributed object storage method and apparatus, a device and a medium.

### BACKGROUND

Object storage services can store and invoke various unstructured data files such as texts, pictures, audios, and videos at any time through a network, and are generally provided to users in the form of cloud services, and have features such as high scalability, low cost, and high durability, and can also effectively meet the massive data storage requirements. However, the existing object storage services have a problem of local overload of a cluster, that is, a load of local nodes of the cluster exceeds the processing capability of the cluster, thereby affecting the service availability. Therefore, there is an urgent need to improve object storage services at present.

### SUMMARY

In order to solve the above technical problems or at least partially solve the above technical problems, the present disclosure provides a distributed object storage method and apparatus, a device and a medium.

An embodiment of the present disclosure provides a distributed object storage method, the method includes: splitting a target object to be stored into a quantity of key-value pair data; determining target partitions corresponding respectively to the quantity of key-value pair data from a plurality of partitions of a preset distributed object storage system; determining, based on a preset partition view, data storage nodes that currently hold the target partitions, to obtain data storage nodes corresponding respectively to the quantity of key-value pair data, where the partition view is used to indicate meta information of the plurality of partitions, the meta information at least includes information of data storage nodes that hold the plurality of partitions, and the data storage node is a storage node of the distributed object storage system; and caching the quantity of key-value pair data into the data storage nodes corresponding respectively to the quantity of key-value pair data.

Optionally, the determining target partitions corresponding respectively to the quantity of key-value pair data from a plurality of partitions of a preset distributed object storage system, includes: separately performing hash processing on the quantity of key-value pair data to obtain hash values corresponding respectively to the quantity of key-value pair data; and determining, based on the hash values corresponding respectively to the quantity of key-value pair data, the target partitions corresponding respectively to the quantity of key-value pair data from the plurality of partitions of the preset distributed object storage system.

Optionally, the plurality of partitions include a first partition, the first partition is a partition that has replica data, the first partition corresponds to a plurality of data storage nodes, and a quantity of equal replica data corresponding to the first partition is distributed on different data storage nodes.

Optionally, the plurality of data storage nodes corresponding to the first partition include a master node and a slave node, the master node is configured to write data into the first partition, the slave node is configured to replicate data written into the first partition by the master node, and any node of the master node and the slave node is configured to read data in the first partition.

Optionally, the plurality of data storage nodes corresponding to the first partition are determined by: determining, based on a uniform allocation policy, plurality of data storage nodes corresponding to each first partition in the plurality of partitions from a currently available data storage node set, where the uniform allocation policy is used to indicate that a difference in a number of partitions held by different data storage nodes is within a preset range.

Optionally, the method further includes: reallocating, in response to the currently available data storage node set changing, the plurality of data storage nodes corresponding to the first partition based on the currently available data storage node set which has been changed and the uniform allocation policy.

Optionally, the target object to be stored does not belong to first-level trending data, the first-level trending data is data of which current popularity is higher than a preset popularity threshold, and the first-level trending data is used to be stored in a client cache.

Optionally, before the splitting a target object to be stored into a quantity of key-value pair data, the method further includes: in response to receiving an object to be stored, determining whether the object to be stored is long-tail data;
in response to the object to be stored being the long-tail data, determining the object to be stored to be the target object to be stored, where the target object to be stored is used to be stored in a data storage node corresponding to a server; and in response to the object to be stored being not the long-tail data, caching the object to be stored in a memory of the server.

An embodiment of the present disclosure further provides a distributed object storage apparatus, which includes an object splitting module, a partition determining module, a node determining module and a data caching module. The object splitting module is configured to split a target object to be stored into a quantity of key-value pair data; the partition determining module is configured to determine target partitions corresponding respectively to the quantity of key-value pair data from a plurality of partitions of a preset distributed object storage system; the node determining module is configured to determine, based on a preset partition view, data storage nodes that currently hold the target partitions, to obtain data storage nodes corresponding respectively to the quantity of key-value pair data, where the partition view is used to indicate meta information of the plurality of partitions, the meta information at least includes information of data storage nodes that hold the plurality of partitions, and the data storage node is a storage node of the distributed object storage system; and the data caching module is configured to cache the quantity of key-value pair data into the data storage nodes corresponding respectively to the quantity of key-value pair data.

An embodiment of the present disclosure further provides an electronic device, and the electronic device includes a processor and a memory. The memory is configured to store instructions executable by the processor, the processor is configured to read the instructions from the memory and execute the instructions to implement the distributed object storage method provided in the embodiments of the present disclosure.

An embodiment of the present disclosure further provides a computer-readable storage medium, the storage medium stores a computer program, and the computer program is configured to execute the distributed object storage method provided in the embodiments of the present disclosure.

An embodiment of the present disclosure further provides a computer program product, which includes a computer program. When the computer program is executed by a processor, the processor is caused to implemented the distributed object storage method provided in the embodiments of the present disclosure.

### BRIEF DESCRIPTION OF DRAWINGS

The drawings here are incorporated into and constitute a part of the present specification, illustrate the embodiments consistent with the present disclosure, and together with the specification, serve to explain the principles of the present disclosure.

In order to more clearly illustrate the technical solutions in the embodiments of the present disclosure, the following briefly introduces the drawings required for describing the embodiments. Apparently, for those of ordinary skills in the art, other drawings may be obtained according to these drawings without creative efforts.

FIG. 1 is a schematic diagram of an overall architecture of a cluster of an object storage service according to an embodiment of the present disclosure;

FIG. 2 is a schematic flowchart of a distributed object storage method according to an embodiment of the present disclosure;

FIG. 3 is a schematic diagram of replication of partition data according to an embodiment of the present disclosure;

FIG. 4 is a schematic diagram of object storage according to an embodiment of the present disclosure;

FIG. 5 is a schematic diagram of partition reallocation according to an embodiment of the present disclosure;

FIG. 6 is a schematic diagram of a multi-level storage architecture according to an embodiment of the present disclosure;

FIG. 7 is a schematic diagram of an application of distributed object storage according to an embodiment of the present disclosure;

FIG. 8 is a schematic structural diagram of a distributed object storage apparatus according to an embodiment of the present disclosure; and

FIG. 9 is a schematic structural diagram of an electronic device according to an embodiment of the present disclosure.

### DETAILED DESCRIPTION

In order to more clearly understand the preceding objectives, features, and advantages of the present disclosure, the solutions of the present disclosure will be further described below. It should be noted that the embodiments of the present disclosure and features in the embodiments may be combined with each other without conflict.

Many specific details are set forth in the following description to facilitate full understanding of the present disclosure, but the present disclosure may further be implemented in other manners different from those described herein. Apparently, the embodiments in the specification are merely a part of rather than all embodiments of the present disclosure.

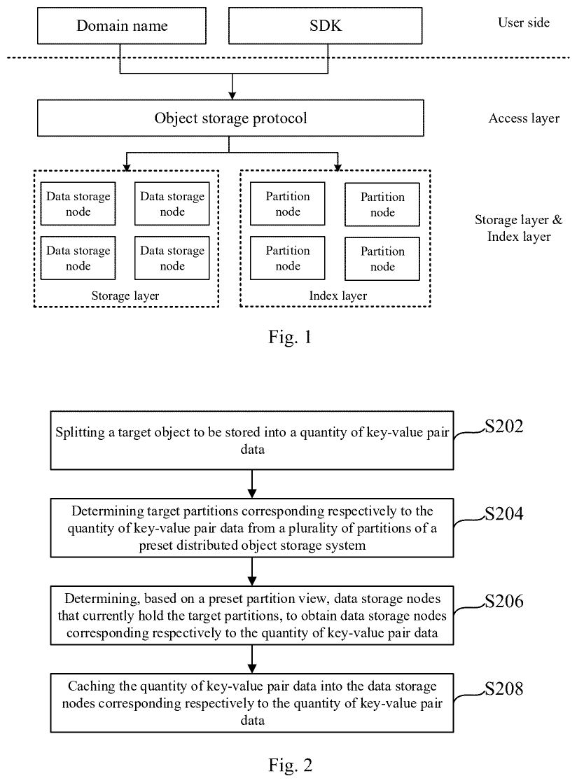

In order to facilitate understanding of object storage services, an embodiment of the present disclosure first provides a schematic diagram of an overall architecture of a cluster of an object storage service as shown in FIG. 1. A user side may initiate a related request such as a read and write request to an access layer in the cluster in a domain name manner or a software development kit (SDK) manner. For ease of understanding, the access layer, a storage layer, and an index layer will be described below.

The access layer may perform parsing based on an object storage protocol, so as to invoke data corresponding to a read and write request in the storage layer and the index layer. Specifically, the access layer may determine, based on the read and write request, corresponding object meta information in the index layer and object data in the storage layer, so as to perform a read input/output (I/O) operation, a write I/O operation, and the like, and then return an operation result to an upper layer according to a protocol requirement.

Storage layer: may include a plurality of data storage nodes, and is configured to store object data. Specifically, a distributed pooled storage system may be used as an underlying storage engine.

Index layer: may include a plurality of partition nodes, and is configured to store object meta information, such as an object name, an object size, a content type, a data distribution on a storage engine, and the like. For example, the index layer may be implemented by means of dictionary ordering technology.

On the basis of the preceding architecture, a problem of local overload of a cluster easily occurs, that is, a load of a local node of the cluster exceeds the processing capability of the cluster, thereby affecting the service availability. Exemplarily, the problem occurs in the following several scenarios.

(1) Trending object scenario: users request to download the same object in a large amount, and data I/O pressure is concentrated on a single partition in the index layer and a few data disks in the storage layer, resulting in overload of a corresponding data node in the index layer or the storage layer.

(2) High queries per second (QPS) download scenario: a user repeatedly reads a batch of data in a high QPS state, and data I/O pressure is concentrated on several nodes in the index layer or the storage layer, resulting in overload of a local node central processing unit (CPU).

(3) High throughput download scenario: a user concurrently loads a batch of large object data, and data bandwidth pressure is concentrated on several nodes in the storage layer, resulting in a disk bandwidth or a network bandwidth of a local node reaching an upper limit.

(4) Download acceleration scenario: in the acceleration scenario, it is generally expected that a data I/O link is as short as possible. On the other hand, considering cost, a slow storage device may be used for underlying indexing and storage.

In order to improve the problem of local overload of a cluster occurring in one or more of the preceding scenarios, embodiments of the present disclosure provide a distributed object storage method and apparatus, a device, and a medium, which may be better applied to the preceding overall architecture of the cluster of the object storage service. For example, functional layers such as the access layer in the preceding architecture may be improved based on the distributed object storage method provided in the embodiments of the present disclosure. For ease of understanding, the following gives a detailed explanation.

FIG. 2 is a schematic flowchart of a distributed object storage method according to an embodiment of the present disclosure. The method may be executed by a distributed object storage apparatus, and the apparatus may be implemented in software and/or hardware, and may generally be integrated into an electronic device, such as a server. As shown in FIG. 2, the method mainly includes the following steps S202 to S208.

Step S202: splitting a target object to be stored into a quantity of key-value pair data. The key-value pair data may also be referred to as a key-value (KV) shard.

The target object is not limited in the embodiment of the present disclosure, and the target object may specifically include object meta information and object data. In some implementations, the target object to be stored may be any received object to be stored. In other implementations, the target object to be stored may be an object that is determined, after a plurality of levels of screening, to be cached in a partition of a data storage node, and the target object is not limited here. The manner of splitting the target object is not limited in the embodiments of the present disclosure. For example, the target object may be converted into key-value pairs in a specific slicing manner. Exemplarily, one or more of field splitting, size splitting, logical splitting, and time series splitting may be performed on the target object, which are merely examples and should not be construed as limitations here. By splitting the target object, no matter how large the target object is, the target object may be split into a smaller quantity of key-value pair data, which is more convenient for subsequent processing.

Step S204: determining target partitions corresponding respectively to the quantity of key-value pair data from a plurality of partitions of a preset distributed object storage system. In practical application, a partition mentioned in the embodiments of the present disclosure may also be referred to as a logical partition corresponding to user data, and the quantity of partitions may be preset when a distributed object storage system (which may also be referred to as a storage cluster) is created, for example, N partitions are preset, and the quantity may be kept unchanged subsequently. In practical application, the partitioning may be performed based on a scale of the distributed object storage system. Specifically, the storage space of the distributed object storage system may be pre-partitioned into N logical partitions for storing user data, that is, the plurality of partitions of the preset distributed object storage system are obtained. After the quantity of key-value pair data is obtained, the target partitions corresponding respectively to the quantity of key-value pair data may be determined based on a partition policy. To ensure that the quantity of key-value pair data of the target object may be scattered and allocated to the plurality of partitions better, the partition policy may be a hash partition policy. Specifically, in some implementations, hash processing may be separately performed on the quantity of key-value pair data to obtain hash values corresponding respectively to the quantity of key-value pair data. The target partitions corresponding respectively to the quantity of key-value pair data are determined from the plurality of partitions of the preset distributed object storage system based on the hash values corresponding respectively to the quantity of key-value pair data. A hash algorithm used for the preceding hash processing may be flexibly set. The embodiments of the present disclosure may perform partitioning by using hash, store each piece of key-value pair data in a manner of random scattering, and correspondingly reduce meta information required to be recorded for each partition. In addition, this manner may also effectively ensure load balance.

Step S206: determining, based on a preset partition view, data storage nodes that currently hold the target partitions, to obtain data storage nodes corresponding respectively to the quantity of key-value pair data. The partition view is used to indicate meta information of the plurality of partitions, the meta information at least includes information of data storage nodes that hold the plurality of partitions, and the data storage node is a storage node of the distributed object storage system. The information of the data storage node includes, for example, identification information of the data storage node. In addition, the information of the data storage node may further include basic information of the node, such as position information and capacity information of the data storage node. By recording the information of the data storage node that holds the partition in the meta information, the data storage node that holds the partition may be accurately positioned. In other words, a correspondence between each partition and a data storage node may be accurately obtained, thereby quickly determining, based on the meta information, the data storage node that holds the target partition on the basis that the target partition is known. In addition, the meta information of the partition may further include information such as a position of the partition and an allowed capacity size, which is not limited here. In practical application, a data storage node may hold a plurality of partitions at the same time, and the target partitions corresponding respectively to the quantity of key-value pair data may be held by different data storage nodes.

Step S208: caching the quantity of key-value pair data into the data storage nodes corresponding respectively to the quantity of key-value pair data.

Through the preceding manners, key-value pair splitting processing can be performed on the target object, and the quantity of key-value pair data is distributed and cached into corresponding data storage nodes based on target partitions corresponding respectively to the quantity of key-value pair data obtained through splitting, so that a purpose of dispersion of the node loads is implemented, thereby effectively alleviating a problem of local overload of a cluster of object storage services.

In some implementations, the plurality of partitions include a first partition, the first partition is a partition that has replica data, the first partition corresponds to a plurality of data storage nodes, and a quantity of equal replica data corresponding to the first partition is distributed on different data storage nodes. In practical application, each of the preceding plurality of partitions may be the first partition, that is, each partition may be a partition that has replica data. It should be understood that data of the first partition itself is held by a corresponding data storage node, and a quantity of replica data obtained by replicating the data of the first partition is also held by different data storage nodes respectively, so it may be considered that the first partition corresponds to the plurality of data storage nodes.

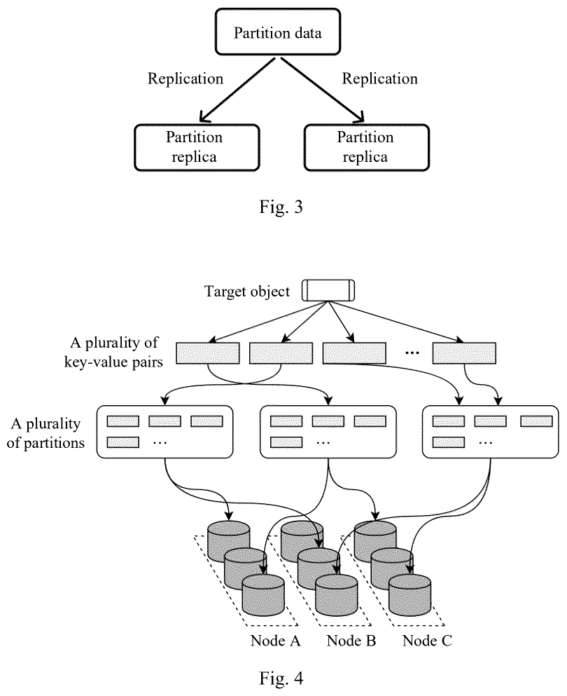

In practical application, data corresponding to a partition may be copied to a plurality of storage devices, and a data reliability and availability problem is solved by means of data redundancy. Even if a single storage device fails, no data loss or unavailability is caused, and at the same time, I/O access pressure may be shared among a plurality of nodes. Exemplarily, as shown in FIG. 3, which is a schematic diagram of replication of partition data, the partition data may be replicated into a plurality of copies, so as to obtain a quantity of replica data. FIG. 3 is merely a simple illustration of an additional replication of two copies, and should not be construed as a limitation. In practical application, the plurality of data storage nodes corresponding to the first partition include a master node and a slave node, the master node is configured to write data into the first partition, the slave node is configured to replicate data written into the first partition by the master node, and any node of the master node and the slave node is configured to read data in the first partition. In other words, all write requests are processed by the master node, and then the data written by the master node is replicated to the slave node in a synchronous or asynchronous manner. The preceding processing mode may be referred to as a master-slave topology mode, and data consistency between the copies may also be effectively ensured through the preceding manners.

For ease of understanding, reference may also be made to FIG. 4, which is a schematic diagram of object storage. It is illustrated in FIG. 4 that a target object to be stored is partitioned into a quantity of key-value pair data, and the quantity of key-value pair data is mapped to different partitions. FIG. 4 briefly illustrates three partitions, and each partition may hold a quantity of key-value pair data. It can be learned from FIG. 4 that the quantity of key-value pair may be scattered and mapped to the plurality of partitions, and a specific mapping manner may depend on a specific algorithm such as the hash partitioning, which is not limited here. Further, FIG. 4 also illustrates that partition data may be placed on different data storage nodes in a form of a plurality of mirror copies. Through the preceding manners, the purpose of dispersion of the node loads is implemented, thereby effectively alleviating a problem of local overload of a cluster.

To further ensure load balance, partitions in the cluster are allocate evenly to various data storage nodes. In some specific implementations, the plurality of data storage nodes corresponding to the first partition are determined by: determining, based on a uniform allocation policy, a plurality of data storage nodes corresponding to each first partition in the plurality of partitions from a currently available data storage node set. The uniform allocation policy is used to indicate that a difference in a number of partitions held by different data storage nodes is within a preset range, and the preset range may be flexibly set, for example, the preset range may be assumed as 0 to M. For any two data storage nodes, in response to the difference between the quantities of partitions held by the two data storage nodes is within the range, it may be considered that the partitions are evenly allocated to the two data storage nodes. The currently available data storage node set may be learned through a node view, and the node view may be used to indicate information of currently available data storage nodes. In practical application, the partitions and corresponding replicas may be evenly allocated to the respective data storage nodes based on the quantity of partitions indicated by the partition view and a replica policy of each partition, and a partition list is generated. The partition list may be used to indicate a partition ID and information of a data storage node that holds each partition (such as an access address, master-slave information, and the like), which is not limited here.

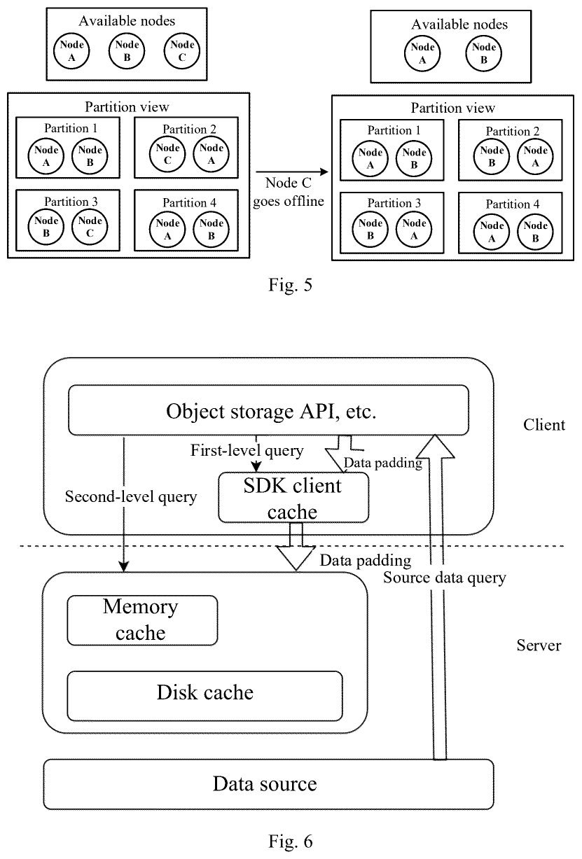

Further, the method provided in the embodiment of the present disclosure further includes: in response to the currently available data storage node set changes, that is, a case where the data storage node goes online or offline occurs, the plurality of data storage nodes corresponding to the first partition may be reallocated based on the currently available data storage node set which has been changed and the uniform allocation policy. For ease of understanding, taking a case where a data storage node goes offline as an example, reference may be made to FIG. 5 which is a schematic diagram of partition reallocation. It is illustrated in the left diagram of FIG. 5 that available nodes are A, B and C. Taking four partitions as an example, each partition corresponds to two data storage nodes, data and a replica corresponding to the partition 1 are held by the node A and the node B respectively. Similarly, the partition 2 corresponds to the node C and the node A, the partition 3 corresponds to the node B and the node C, and the partition 4 corresponds to the node A and the node B. In other words, the node A holds data of the partition 1, the partition 2 and the partition 4 at the same time, the node B holds data of the partition 1, the partition 3 and the partition 4, and the node C holds data of the partition 2, the partition 3 and the partition 4. The preceding allocation manner may achieve load balance better. After the node C goes offline, partition reallocation is performed based on the uniform allocation policy, which may be seen in the right diagram of FIG. 5. Since the partition 1 and the partition 4 both correspond to the node A and the node B, the partition 1 and the partition 4 are not affected. The partition 2 originally corresponds to the node C and the node A, and is reallocated to correspond to the node B and the node A. the partition 3 originally corresponds to the node B and the node C, and is reallocated to correspond to the node B and the node A. In other words, after reallocation, both the node A and the node B hold data of the partition 1, the partition 2, the partition 3 and the partition 4 at the same time, and load balance may still be achieved.

Considering that the existing single disk cache manner has certain limitations, in a case of trending request traffic, there is still a risk of stability damage when the load of a single disk is too high. Moreover, in order to reasonably allocate cache resources and improve the read-write capability of a single machine with high concurrency and low latency, the embodiments of the present disclosure may adopt a multi-level cache policy to directly cache first-level trending data (which may also be referred to as head trending data) on a client. That is, the target object to be stored in the embodiments of the present disclosure does not belong to the first-level trending data, the first-level trending data is data of which current popularity is higher than a preset popularity threshold, and the first-level trending data is used to be stored in a cache on a client. Exemplarily, a Least Recently Used (LRU) algorithm may be used to preferentially eliminate the least recently used data, so that the first-level trending data is cached on the client, a small space (such as 1%) on the client is used to cache the recent first-level trending data, so as to quickly respond to a related request of a user for the data, greatly reduce a delay of such data, and reduce the pressure on the server. As mentioned above, the first-level trending data may be cached on the client, and non-first-level trending data may be stored through the server. Specifically, before the step of splitting the target object to be stored into a quantity of key-value pair data is performed, the method provided in the embodiment of the present disclosure further includes the following steps a to c.

In the step a: in response to receiving an object to be stored, determining whether the object to be stored is long-tail data. In response to the object to be stored being the long-tail data, the step b is performed, and in response to the object to be stored being not the long-tail data, the step c is performed. It should be understood that most of the stored data involved in object storage services is in long-tail distribution, and there is a large amount of data with a low access frequency, and such data is the long-tail data. For the identification manner of long-tail data, reference may be made to the related art, which will not be repeated here. Exemplarily, a Bloom filter may be used to determine whether the object to be stored is the long-tail data.

In the step b: determining the object to be stored to be the target object to be stored, where the target object to be stored is used to be stored in a data storage node corresponding to a server. In response to the object to be stored being the long-tail data, it may be considered to use the preceding method provided in the embodiments of the present disclosure to scatter and store a quantity of key-value pair data obtained by splitting the object to be stored into the plurality of data storage nodes, that is, to store the data through an external memory corresponding to the server. In other words, object storage is performed through a disk corresponding to the server, and data may be written in a manner such as Append Only, that is, each writing is appended to an end of existing data on the disk, rather than updated or deleted at a random position, which helps reduce random read-write operations to the disk and improve the write efficiency. In addition, a First In First Out (FIFO) algorithm may be used to eliminate the earliest written data. In other words, when the space needs to be released, deletion starts from the earliest written data. In practical application, the preceding target object to be stored may implement disk cache by means of a partition engine of the server.

In the step c: caching the object to be stored in a memory of the server. In response to the object to be stored being not the long-tail data, it indicates that the data is relatively trending data, so the data may be preferentially stored in the memory of the server, and admission control may be performed by means of a Tiny Least Frequently Used (TinyLFU) algorithm, such as determining whether the data may enter the memory cache. When there is new data that needs to be stored, in response to the memory being full, relatively less frequently used data may be eliminated according to the TinyLFU algorithm. In addition, a mandatory admission policy may further be set to allow some objects to be stored to be written into the memory of the server even if the objects to be stored are not permitted by the TinyLFU.

For ease of understanding, reference may be made to FIG. 6 which is a schematic diagram of a multi-level storage architecture. The first-level trending data may be preferentially cached in the cache on the client, the relatively trending data may be cached into the memory cache of the server, and the subsequent data may be stored into the disk cache of the server. In practical application, the memory cache of the server may be implemented by means of a memory engine of the server, and the memory of the server may be used to store data, so as to provide a fast access speed. The disk cache of the server may be implemented by means of a partition engine of the server, that is, partition storage may be implemented by means of a corresponding data storage node of the server. For example, data that is not cached on the client or in the memory of the server may be cached in a disk of the server. In addition, FIG. 6 also illustrates a data source, which may perform persistent data storage. When querying the stored data, data query (first-level query) may also be preferentially performed in the cache on the client, then the data stored on the server is queried (second-level query), and then the source data query may also be implemented.

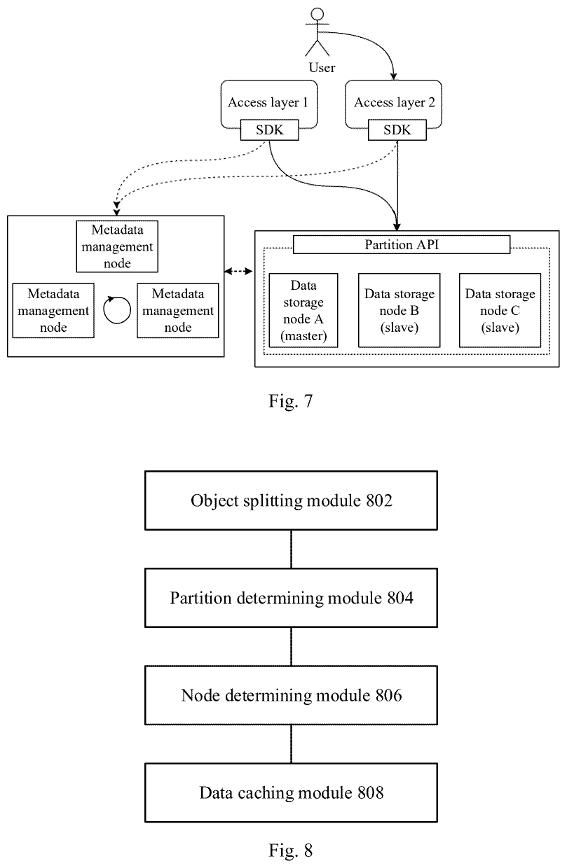

Further, for ease of understanding, the embodiments of the present disclosure further provide a schematic diagram of an application of distributed object storage as shown in FIG. 7. The user may implement object storage through an access layer 1 or an access layer 2. Exemplarily, the access layer 1 may be an application programming interface of object storage, and may specifically correspond to SDK traffic. The access layer 2 may be a routing server, and may specifically correspond to domain name traffic. The SDKs indicated by the access layer 1 and the access layer 2 respectively may be SDKs that provide a cache service, that is, the access layer needs to access the cache service based on the SDK. In other words, the access layer reads from and writes to the cache through the SDK that provides the cache service, and the target object to be stored may be converted into key-value pairs through a specific slicing manner and written into the cache service. The cache service corresponds to two types of servers, one type of the server corresponds to a metadata management node, and the other type of the server corresponds to a data storage node. The metadata management node is configured to be responsible for functions such as cluster data partitioning, partition scheduling and replica leader election, and distribution information of the partition may be queried through the metadata management node, so as to implement data access. In FIG. 7, the circled arrows illustrated among a plurality of metadata management nodes are used to briefly indicate that synchronization and leader selection may be performed between the plurality of metadata management nodes. The data storage node may be configured to provide a semantic interface such as a key-value pair, and may read from and write to held partition data. It is briefly illustrated in FIG. 7 that the access layer communicates with a partition application programming interface (API) through the SDK that provides the cache service, so as to implement data reading and writing through the data storage node. Moreover, the partition data may have a plurality of copies. Correspondingly, a plurality of data storage nodes corresponding to the partition may be divided into a master node and a slave node. The data storage node and the metadata management node may interact with each other, so as to implement data reading and writing. Subsequently, when data is read, the metadata management node may confirm which data storage node the partition corresponding to the key-value pair data is positioned in, so as to accurately access the node.

In conclusion, the distributed object storage method provided in the embodiment of the present disclosure has the following advantages.

(1) An object is sliced into a plurality of key-value pairs, and the plurality of key-value pairs may be scattered and stored in a plurality of preset partitions, thereby being held by a plurality of data storage nodes. That is, the object may be split and stored on the plurality of data storage nodes, so that a problem of storage space of a single machine may be effectively solved. In addition, a load is dispersed to a plurality of nodes, which not only helps implement load balance, but also effectively improves the service throughput.

(2) Multi-replica data redundancy is implemented by means of data replication, and replica data of a partition is synchronized to a plurality of data storage nodes, so that a certain disaster tolerance capability is provided for cached data. In addition, in practical application, a replica positioned on different data storage nodes may be read based on a requirement, so that a problem that requests is concentrated on a single node in a trending scenario is solved, and an upper limit of a read capability in a cache system is improved. Meanwhile, data consistency between the replicas may be effectively ensured by means of data replication.

(3) Automatic data scheduling may be implemented. That is, in the case where a data storage node goes online or offline, partition reallocation may be automatically performed according to a node load, for example, a partition is automatically scheduled to a data storage node with a lower load without manual intervention, so that the elastic expansion and contraction capability of the cache system is better implemented, and the load balance is effectively ensured.

(4) A multi-level cache policy is proposed. That is, a read-write capability with high concurrency and low latency is provided by means of a combination of the memory cache and the disk cache, so that the read-write capability of a single machine with high concurrency and low latency may be effectively enhanced.

In conclusion, through the preceding methods provided in the embodiments of the present disclosure, the problem of local overload of a cluster may be greatly alleviated, such as alleviating the trending traffic problem of object storage services, reducing the probability of accidents caused by a sudden increase in trending traffic, and improving the stability of the object storage system. In addition, trending requests of users may be responded to quickly, and the average delay of read requests for accessing the cache is effectively reduced.

Corresponding to the preceding distributed object storage method, an embodiment of the present disclosure further provides a distributed object storage apparatus, and FIG. 8 is a schematic structural diagram of a distributed object storage apparatus according to an embodiment of the present disclosure. The apparatus may be implemented in software and/or hardware, and may generally be integrated into an electronic device. As shown in FIG. 8, the distributed object storage apparatus includes an object splitting module 802, a partition determining module 804, a node determining module 806 and a data caching module 808.

The object splitting module 802 is configured to a target object to be stored into a quantity of key-value pair data.

The partition determining module 804 is configured to determine target partitions corresponding respectively to the quantity of key-value pair data from a plurality of partitions of a preset distributed object storage system.

The node determining module 806 is configured to determine, based on a preset partition view, data storage nodes that currently hold the target partitions, to obtain data storage nodes corresponding respectively to the quantity of key-value pair data, where the partition view is used to indicate meta information of the plurality of partitions, the meta information at least includes information of data storage nodes that hold the plurality of partitions, and the data storage node is a storage node of the distributed object storage system.

The data caching module 808 is configured to cache the quantity of key-value pair data into the corresponding data storage nodes corresponding respectively to the quantity of key-value pair data.

Through the preceding apparatus, key-value pair splitting processing can be performed on the target object, and the quantity of key-value pair data obtained through splitting is distributed and cached into corresponding partitions, so that a purpose of dispersion of the node loads is achieved, thereby effectively alleviating a problem of local overload of a cluster of object storage services.

In some implementations, the partition determining module 804 is further configured to: separately perform hash processing on the quantity of key-value pair data to obtain hash values corresponding respectively to the quantity of key-value pair data; and determine, based on the hash values corresponding respectively to the quantity of key-value pair data, the target partitions corresponding respectively to the quantity of key-value pair data from the plurality of partitions of the preset distributed object storage system.

In some implementations, the plurality of partitions include a first partition, the first partition is a partition that has replica data, the first partition corresponds to a plurality of data storage nodes, and a quantity of equal replica data corresponding to the first partition is distributed on different data storage nodes.

In some implementations, the plurality of data storage nodes corresponding to the first partition include a master node and a slave node, the master node is configured to write data into the first partition, the slave node is configured to replicate data written into the first partition by the master node, and any node of the master node and the slave node is configured to read data in the first partition.

In some implementations, the plurality of data storage nodes corresponding to the first partition are determined by: determining, based on a uniform allocation policy, a plurality of data storage nodes corresponding to each first partition in the plurality of partitions from a currently available data storage node set, where the uniform allocation policy is used to indicate that a difference in a number of partitions held by different data storage nodes is within a preset range.

In some implementations, the apparatus further includes a reallocation module, which is configured to reallocate, in response to the currently available data storage node set changing, the plurality of data storage nodes corresponding to the first partition based on the currently available data storage node set which has been changed and the uniform allocation policy.

In some implementations, the target object to be stored does not belong to first-level trending data, the first-level trending data is data of which current popularity is higher than a preset popularity threshold, and the first-level trending data is used to be stored in a cache on a client.

In some implementations, the apparatus further includes a hierarchical caching module, which is configured to: in response to receiving an object to be stored, determine whether the object to be stored is long-tail data; in response to the object to be stored being the long-tail data, determine the object to be stored to be the target object to be stored, where the target object to be stored is used to be stored in a data storage node corresponding to a server; and in response to the object to be stored being not the long-tail data, cache the object to be stored in a memory of the server.

The distributed object storage apparatus provided in the embodiment of the present disclosure may perform the distributed object storage method provided in any embodiment of the present disclosure, and has function modules and beneficial effects corresponding to the method performed.

It should be clearly understood by those skilled in the art that for ease and brevity of description, reference may be made to the corresponding processes in the method embodiments for the specific working process of the apparatus embodiments described above, which will not be repeated here.

An embodiment of the present disclosure provides an electronic device, and the electronic device includes a memory and a processor. The memory is configured to store a computer program; and the processor is configured to execute the computer program in the memory to implement the steps of any one of the methods in the present disclosure.

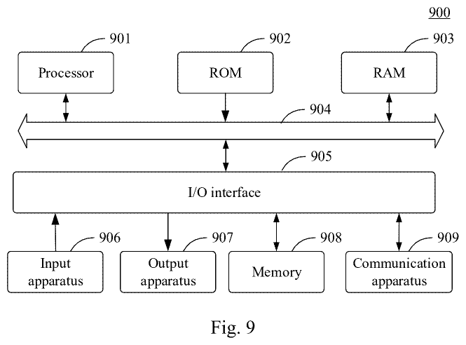

Reference is made to FIG. 9 below, which illustrates a schematic structural diagram of an electronic device 900 suitable for implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a tablet computer, a portable multimedia player (PMP), a vehicle-mounted terminal (such as a vehicle navigation terminal), etc., and a stationary terminal such as a digital TV, a desktop computer, etc. The electronic device shown in FIG. 9 is merely an example, and should not impose any limitation to the function and scope of use of the embodiments of the present disclosure.

As shown in FIG. 9, the electronic device 900 may include a processor (such as a central processing unit, a graphics processing unit, etc.) 901, which may perform various appropriate actions and processing according to a program stored in a read-only memory (ROM) 902 or a program loaded into a random access memory (RAM) 903 from a memory 908. The RAM 903 further stores various programs and data required for the operation of the electronic device 900. The processor 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906, such as a touchscreen, a touchpad, a keyboard, a mouse, a camera, a microphone, an accelerometer, a gyroscope, etc.; an output apparatus 907, such as a liquid crystal display (LCD), a speaker, a vibrator, etc.; a memory 908 such as a magnetic tape, a hard disk, etc.; and a communication apparatus 909. The communication apparatus 909 may allow the electronic device 900 to communicate with other devices in a wireless or wired manner to exchange data. Although FIG. 9 illustrates the electronic device 900 having various apparatuses, it should be understood that not all of the illustrated apparatuses are necessarily implemented or provided. Alternatively, more or fewer apparatuses may be implemented or provided.

In particular, according to the embodiments of the present disclosure, the process described above with reference to the flowcharts may be implemented as a computer software program. For example, an embodiment of the present disclosure includes a computer program product, which includes a computer program loaded on a non-transitory computer-readable medium, and the computer program includes program codes for executing the method shown in the flowcharts. In such an embodiment, the computer program may be downloaded and installed from the network through the communication apparatus 909, or installed from the memory 908, or installed from the ROM 902. When the computer program is executed by the processor 901, the preceding functions defined in the methods of the embodiments of the present disclosure are executed.

In addition to the preceding method and device, the embodiments of the present disclosure may also be a computer program product, which includes computer program instructions, and when the computer program instructions are run by a processor, the processor is caused to execute the method provided in the embodiments of the present disclosure. The computer program product may be written in any combination of one or more programming languages for performing the operations of the embodiments of the present disclosure, where the programming languages include object-oriented programming languages such as Java, C++, etc., and also include conventional procedural programming languages, such as “C” language or similar programming languages. The program codes may be executed entirely on a user computing device, partly on a user device, as an independent software package, partly on a user computing device and partly on a remote computing device, or entirely on a remote computing device or a server.

In addition, the embodiments of the present disclosure may also be a computer-readable storage medium, which stores computer program instructions, and when the computer program instructions are run by a processor, the processor is caused to execute the distributed object storage method provided in the embodiments of the present disclosure.

The computer-readable storage medium may be any combination of one or more readable media. The readable medium may be a readable signal medium or a readable storage medium. The readable storage medium may include, for example, but not limited to, an electrical, magnetic, optical, electromagnetic, infrared, or semiconductor system, apparatus, or device, or any combination of the foregoing. More specific examples of the readable storage medium (a non-exhaustive list) include: an electrical connection having one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

An embodiment of the present disclosure further provides a computer program product, including a computer program/instruction, and when the computer program/instruction is executed by a processor, the distributed object storage method in the embodiment of the present disclosure is implemented.

It should be understood that before using the technical solutions disclosed in the embodiments of the present disclosure, users should be informed of the type, scope of use, usage scenario, and the like of personal information involved in the present disclosure through appropriate means in accordance with relevant laws and regulations, and authorization from the users should be obtained.

For example, when receiving an active request from a user, a prompt message is sent to the user to explicitly prompt the user that the operation requested to be performed will require acquisition and use of the user's personal information. In this way, the user can independently select whether to provide the personal information to software or hardware such as an electronic device, an application, a server, or a storage medium that performs an operation of the technical solution of the present disclosure according to the prompt message.

As an optional but not limiting implementation, a manner of sending a prompt message to the user in response to receiving an active request from the user may be, for example, a pop-up window, and the prompt message may be presented in text in the pop-up window. In addition, the pop-up window may also carry a selection control for the user to select “agree” or “disagree” to provide personal information to the electronic device.

It should be understood that the preceding process of notifying and obtaining the user's authorization is only illustrative and does not constitute a limitation to the implementations of the present disclosure, and other manners that satisfy relevant laws and regulations may also be applied to the implementations of the present disclosure.

It should be noted that in this text, relational terms such as “first” and “second” are only used to distinguish one entity or operation from another entity or operation, and do not necessarily require or imply that there is any such actual relationship or sequence between these entities or operations. Moreover, the term “include/comprise” or any other variation thereof is intended to cover non-exclusive inclusion, such that a process, method, article, or device that includes a series of elements includes not only those elements, but also other elements not explicitly listed, or also includes elements inherent to such a process, method, article, or device. Without more limitations, an element defined by a statement “include/comprise one . . . ” does not exclude that there are other identical elements in the process, method, article, or device that include the element.

The preceding descriptions are merely specific implementations of the present disclosure, which enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments described herein, but should conform to the widest scope consistent with the principles and novel features disclosed herein.

1. A distributed object storage method, comprising:
splitting a target object to be stored into a quantity of key-value pair data;
determining target partitions corresponding respectively to the quantity of key-value pair data from a plurality of partitions of a preset distributed object storage system;
determining, based on a preset partition view, data storage nodes that currently hold the target partitions, to obtain data storage nodes corresponding respectively to the quantity of key-value pair data, wherein the partition view is used to indicate meta information of the plurality of partitions, the meta information at least comprises information of data storage nodes that hold the plurality of partitions, and the data storage node is a storage node of the distributed object storage system; and
caching the quantity of key-value pair data into the data storage nodes corresponding respectively to the quantity of key-value pair data.

2. The method according to claim 1, wherein the determining target partitions corresponding respectively to the quantity of key-value pair data from a plurality of partitions of a preset distributed object storage system, comprises:
separately performing hash processing on the quantity of key-value pair data to obtain hash values corresponding respectively to the quantity of key-value pair data; and
determining, based on the hash values corresponding respectively to the quantity of key-value pair data, the target partitions corresponding respectively to the quantity of key-value pair data from the plurality of partitions of the preset distributed object storage system.

3. The method according to claim 1, wherein the plurality of partitions comprise a first partition, the first partition is a partition that has replica data, the first partition corresponds to a plurality of data storage nodes, and a quantity of equal replica data corresponding to the first partition is distributed on different data storage nodes.

4. The method according to claim 3, wherein the plurality of data storage nodes corresponding to the first partition comprise a master node and a slave node, the master node is configured to write data into the first partition, the slave node is configured to replicate data written into the first partition by the master node, and any node of the master node and the slave node is configured to read data in the first partition.

5. The method according to claim 3, wherein the plurality of data storage nodes corresponding to the first partition are determined by:
determining, based on a uniform allocation policy, a plurality of data storage nodes corresponding to each first partition in the plurality of partitions from a currently available data storage node set, wherein the uniform allocation policy is used to indicate that a difference in a number of partitions held by different data storage nodes is within a preset range.

6. The method according to claim 5, further comprising:
reallocating, in response to the currently available data storage node set changing, the plurality of data storage nodes corresponding to the first partition based on the currently available data storage node set which has been changed and the uniform allocation policy.

7. The method according to claim 1, wherein the target object to be stored does not belong to first-level trending data, the first-level trending data is data of which current popularity is higher than a preset popularity threshold, and the first-level trending data is used to be stored in a cache on a client.

8. The method according to claim 7, wherein before the splitting a target object to be stored into a quantity of key-value pair data, the method further comprises:
in response to receiving an object to be stored, determining whether the object to be stored is long-tail data;
in response to the object to be stored being the long-tail data, determining the object to be stored to be the target object to be stored, wherein the target object to be stored is used to be stored in a data storage node corresponding to a server; and
in response to the object to be stored being not the long-tail data, caching the object to be stored in a memory of the server.

9. An electronic device, comprising:
at least one memory, configured to store a computer program; and
at least one processor, configured to execute the computer program in the at least one memory to implement a distributed object storage method,
wherein the distributed object storage method comprises:
splitting a target object to be stored into a quantity of key-value pair data;
determining target partitions corresponding respectively to the quantity of key-value pair data from a plurality of partitions of a preset distributed object storage system;
determining, based on a preset partition view, data storage nodes that currently hold the target partitions, to obtain data storage nodes corresponding respectively to the quantity of key-value pair data, wherein the partition view is used to indicate meta information of the plurality of partitions, the meta information at least comprises information of data storage nodes that hold the plurality of partitions, and the data storage node is a storage node of the distributed object storage system; and
caching the quantity of key-value pair data into the data storage nodes corresponding respectively to the quantity of key-value pair data.

10. The electronic device according to claim 9, wherein the determining target partitions corresponding respectively to the quantity of key-value pair data from a plurality of partitions of a preset distributed object storage system, comprises:
separately performing hash processing on the quantity of key-value pair data to obtain hash values corresponding respectively to the quantity of key-value pair data; and
determining, based on the hash values corresponding respectively to the quantity of key-value pair data, the target partitions corresponding respectively to the quantity of key-value pair data from the plurality of partitions of the preset distributed object storage system.

11. The electronic device according to claim 9, wherein the plurality of partitions comprise a first partition, the first partition is a partition that has replica data, the first partition corresponds to a plurality of data storage nodes, and a quantity of equal replica data corresponding to the first partition is distributed on different data storage nodes.

12. The electronic device according to claim 11, wherein the plurality of data storage nodes corresponding to the first partition comprise a master node and a slave node, the master node is configured to write data into the first partition, the slave node is configured to replicate data written into the first partition by the master node, and any node of the master node and the slave node is configured to read data in the first partition.

13. The electronic device according to claim 11, wherein the plurality of data storage nodes corresponding to the first partition are determined by:
determining, based on a uniform allocation policy, a plurality of data storage nodes corresponding to each first partition in the plurality of partitions from a currently available data storage node set, wherein the uniform allocation policy is used to indicate that a difference in a number of partitions held by different data storage nodes is within a preset range.

14. The electronic device according to claim 13, wherein the distributed object storage method further comprises:
reallocating, in response to the currently available data storage node set changing, the plurality of data storage nodes corresponding to the first partition based on the currently available data storage node set which has been changed and the uniform allocation policy.

15. A non-transitory computer-readable storage medium, wherein the non-transitory computer-readable storage medium stores a computer program, and the computer program is configured to execute a distributed object storage method, and the distributed object storage method comprises:
splitting a target object to be stored into a quantity of key-value pair data;
determining target partitions corresponding respectively to the quantity of key-value pair data from a plurality of partitions of a preset distributed object storage system;
determining, based on a preset partition view, data storage nodes that currently hold the target partitions, to obtain data storage nodes corresponding respectively to the quantity of key-value pair data, wherein the partition view is used to indicate meta information of the plurality of partitions, the meta information at least comprises information of data storage nodes that hold the plurality of partitions, and the data storage node is a storage node of the distributed object storage system; and
caching the quantity of key-value pair data into the data storage nodes corresponding respectively to the quantity of key-value pair data.

16. The non-transitory computer-readable storage medium according to claim 15, wherein the determining target partitions corresponding respectively to the quantity of key-value pair data from a plurality of partitions of a preset distributed object storage system, comprises:
separately performing hash processing on the quantity of key-value pair data to obtain hash values corresponding respectively to the quantity of key-value pair data; and
determining, based on the hash values corresponding respectively to the quantity of key-value pair data, the target partitions corresponding respectively to the quantity of key-value pair data from the plurality of partitions of the preset distributed object storage system.

17. The non-transitory computer-readable storage medium according to claim 15, wherein the plurality of partitions comprise a first partition, the first partition is a partition that has replica data, the first partition corresponds to a plurality of data storage nodes, and a quantity of equal replica data corresponding to the first partition is distributed on different data storage nodes.

18. The non-transitory computer-readable storage medium according to claim 17, wherein the plurality of data storage nodes corresponding to the first partition comprise a master node and a slave node, the master node is configured to write data into the first partition, the slave node is configured to replicate data written into the first partition by the master node, and any node of the master node and the slave node is configured to read data in the first partition.

19. The non-transitory computer-readable storage medium according to claim 17, wherein the plurality of data storage nodes corresponding to the first partition are determined by:
determining, based on a uniform allocation policy, a plurality of data storage nodes corresponding to each first partition in the plurality of partitions from a currently available data storage node set, wherein the uniform allocation policy is used to indicate that a difference in a number of partitions held by different data storage nodes is within a preset range.

20. The non-transitory computer-readable storage medium according to claim 19, the distributed object storage method further comprises:
reallocating, in response to the currently available data storage node set changing, the plurality of data storage nodes corresponding to the first partition based on the currently available data storage node set which has been changed and the uniform allocation policy.
